(19) United States
(12) Patent Application Publication
(10) Pub. No.: US 2006/0184655 A1
(43) Pub. Date: Aug. 17, 2006

(54) Traffic analysis

(76) Inventor: Brandon Shalton, Austin, TX (US)

Correspondence Address: PERKINS COIE LLP, P.O. BOX 2168, MENLO PARK, CA, 94026, US

(21) Appl. No.: 11/323,330

(22) Filed: Dec. 30, 2005

Related U.S. Application Data
(60) Provisional application No. 60/640,797, filed on Dec. 30, 2004.

(51) Int. Cl. G06F 15/173

(52) U.S. Cl. 709/223

(57) ABSTRACT

A method, system and apparatus for traffic flow reporting for websites is provided. In one embodiment, the invention is a method. The method includes receiving a request to review traffic of a domain. The method further includes accessing traffic information for the domain. The method also includes accessing link information for the domain. Additionally, the method includes correlating link information with traffic information for the domain to produce a representation of linkages and traffic through linkages. Moreover, the method includes presenting the representation of linkages and traffic through linkages responsive to the request. The method may further include receiving keywords and filtering the link information based on keywords of corresponding websites. In a further embodiment, the invention is a method. The method includes receiving a request to review links of a domain. Moreover, the method includes receiving a set of keywords to review. The method also includes accessing link information for the domain. Additionally, the method includes correlating link information for the domain to produce a representation of linkages. The method further include correlating keyword information for websites associated with links to link information in the representation of linkages. The representation of linkages includes representation of keywords on associated webpages. The method also includes presenting the representation of linkages responsive to the request.

### CROSS-REFERENCE TO RELATED APPLICATION

This application claims priority to application Ser. No. 60/______, entitled “Traffic Analysis” and filed on Dec. 30, 2004, which is hereby incorporated herein by reference.

### FIELD

The present invention, in various embodiments, generally relates to webpage analysis, and more specifically to traffic and linkage analysis of web domains.

### BACKGROUND

In many ways, web commerce is well established. People purchase goods and services over the web. Website operators advertise websites and link to other websites. Search engines provide a wealth of websites based on queries of what websites relate to various search terms. If someone wants to find a website, it can be found.

In many other ways, web commerce is in its infancy. It is not yet clear how users choose which website to visit. With a classical merchant storefront, certain factors are known to influence business. For example, location of the storefront has a large effect on business potential. Connections within the community may have similar effects. Advertising also often has measurable effects. Additionally, simple directory listings in large communities can enhance a flow of customers to a business. Little of this is applicable to websites.

Websites do not depend on a geographical location. Similarly, ties within a local community often have little to do with traffic from around the globe. However, ties within the web community, such as links with other sites may have significant effects on web traffic. How to measure traffic effects and enhance traffic is not at all apparent. Measuring links can be done. Moreover, traffic statistics can be kept. However, options for enhancing traffic are not obvious. Thus, it may be useful to provide a method of analyzing linkages and traffic. Moreover, it may be useful to provide reports of where traffic is coming from and thereby allow for identification of potential changes in the status quo.

### SUMMARY

The present invention is described and illustrated in conjunction with systems, apparatuses and methods of varying scope. In addition to the aspects of the present invention described in this summary, further aspects of the invention will become apparent by reference to the drawings and by reading the detailed description that follows.

A method, system and apparatus for traffic flow reporting for websites is provided. In one embodiment, the invention is a method. The method includes receiving a request to review traffic of a domain. The method further includes accessing traffic information for the domain. The method also includes accessing link information for the domain. Additionally, the method includes correlating link information with traffic information for the domain to produce a representation of linkages and traffic through linkages. Moreover, the method includes presenting the representation of linkages and traffic through linkages responsive to the request.

In another embodiment, the invention is a system. The system includes a processor. The system includes a memory, a user interface and a network interface all coupled to the processor. The system further includes a linkage repository coupled to the processor. The system also includes a traffic repository coupled to the processor. The system further includes a linkage and traffic analysis module coupled to the processor.

In still another embodiment, the invention is a method. The method includes launching a web crawling application. The method also includes receiving link information from the web crawling application. The method further includes storing the link information in a link database. The method may further include seeding the web crawling application with domains or URLs from a source.

In another embodiment, the invention is a method. The method include receiving a request to review links of a domain. Additionally, the method includes accessing link information for the domain. Moreover, the method includes correlating link information for the domain to produce a representation of linkages. The method also includes presenting the representation of linkages responsive to the request.

In yet another embodiment, the invention is a method. The method includes receiving a request to review traffic of a domain. The method also includes accessing link information for the domain. The method further includes searching for keywords on webpages. Additionally, the method includes correlating link information with keyword information for webpages to produce a representation of linkages and keywords. Moreover, the method includes presenting the representation of linkages and keywords responsive to the request.

The method may optionally involve receiving keywords to be used to highlight which webpages are using the provided keywords. The websites searched (where the search is conducted) for keywords may be the websites linked to the domain in question in some embodiments. In other embodiments, the websites searched for keywords may be a set of websites accessible through the search engine (e.g. websites for which the search engine has data) even though some of those websites may not be linked to the domain in question.

In still another embodiment, the invention is a system. The system includes a processor. The system also includes a memory, a user interface and a network interface all coupled to the processor. The system further includes a linkage repository coupled to the processor. The system also includes a keyword repository coupled to the processor. The system further includes a linkage and keyword analysis module coupled to the processor. The system may also include a keyword search module coupled to the processor. The keyword repository and the linkage repository may be parts of a single repository, or separate repositories for example.

In a further embodiment, the invention is a method. The method includes receiving a request to review links of a domain. Moreover, the method includes receiving a set of keywords to review. The method also includes accessing link information for the domain. Additionally, the method includes correlating link information for the domain to produce a representation of linkages. The method further include correlating keyword information for websites associated with links to link information in the representation of linkages. The representation of linkages includes representation of keywords on associated webpages. The method also includes presenting the representation of linkages responsive to the request.

Embodiments of the invention presented are exemplary and illustrative in nature, rather than restrictive. The scope of the invention is determined by the appended claims.

### BRIEF DESCRIPTION OF THE DRAWINGS

Embodiments of the invention are illustrated in the figures. However, the embodiments and figures are illustrative rather than limiting, they provide examples of the invention. Limitations on the invention should only be determined from the attached claims.

FIG. 1 illustrates an embodiment of a network of websites.

FIG. 2A illustrates an embodiment of a user display for reporting link data for a website.

FIG. 2B illustrates an embodiment of an entry for a website.

FIG. 3 illustrates an embodiment of a method of providing a report for a website.

FIG. 4 illustrates an embodiment of a method of obtaining linkage data for websites.

FIG. 5 illustrates an embodiment of a system for providing a report for a website.

FIG. 6 illustrates another embodiment of a network of websites or web domains.

FIG. 7 illustrates an embodiment of a network or system which may be used with websites.

FIG. 8 illustrates an embodiment of a machine or system which may be used with websites.

FIG. 9 illustrates another embodiment of an entry for a website.

FIG. 10 illustrates another embodiment of a system for cataloguing links within a network.

FIG. 11 illustrates an alternate embodiment of a system for cataloguing links within a network.

FIG. 12 illustrates an embodiment of a method for generating a report.

FIG. 13 illustrates another embodiment of a system for generating a report.

FIG. 14 illustrates another embodiment of a method for generating a report including keywords.

FIG. 15 illustrates yet another embodiment of a system for generating a report including keywords.

### DETAILED DESCRIPTION

The present invention is described and illustrated in conjunction with systems, apparatuses and methods of varying scope. In addition to the aspects of the present invention described in this summary, further aspects of the invention will become apparent by reference to the drawings and by reading the detailed description that follows.

In one embodiment, the invention is a method. The method includes receiving a request to review traffic of a domain. The method further includes accessing traffic information for the domain. The method also includes accessing link information for the domain. Additionally, the method includes correlating link information with traffic information for the domain to produce a representation of linkages and traffic through linkages. Moreover, the method includes presenting the representation of linkages and traffic through linkages responsive to the request.

The method may further include launching a web crawling application. The method may also include receiving link information from the web crawling application. The method may additionally include storing the link information in a link database. In the method, the link information for the domain may be accessed from the link database.

Similarly, the method may include requesting traffic information from a server. The method may also include receiving the traffic information from the server. The method may further include storing the traffic information in a traffic database. And the method may include the traffic information for the domain is accessed from the traffic database.

In some embodiments of the method, the representation of linkages includes a count of direct linkages to the domain and a count of direct linkages to sites having direct linkages to the domain. In some embodiments of the method, the representation of linkages includes a count of traffic along a direct link and a count of traffic along a link to a site resulting in traffic along a direct link. Moreover, in some embodiments, the representation of linkages further includes a count of secondary sites having direct linkages to sites having direct linkages to the domain, and where the secondary sites each have links to at least two sites having direct linkages to the domain.

The method may further include monetizing presenting the representation or requesting the review of traffic. Moreover, the method may be embodied in a medium as a set of instructions. When the instructions are executed by a processor, the method is performed by the processor and an accompanying system.

In another embodiment, the invention is a system. The system includes a processor. The system includes a memory, a user interface and a network interface all coupled to the processor. The system further includes a linkage repository coupled to the processor. The system also includes a traffic repository coupled to the processor. The system further includes a linkage and traffic analysis module coupled to the processor. The system may further include means for exploring links among websites and reporting those links to the linkage repository. The system may also include a linkage web crawler.

In still another embodiment, the invention is a method. The method includes launching a web crawling application. The method also includes receiving link information from the web crawling application. The method further includes storing the link information in a link database. The method may further include seeding the web crawling application with domains or URLs from a source.

In another embodiment, the invention is a method. The method include receiving a request to review links of a domain. Additionally, the method includes accessing link information for the domain. Moreover, the method includes correlating link information for the domain to produce a representation of linkages. The method also includes presenting the representation of linkages responsive to the request.

In a further embodiment, the invention is a method. The method includes receiving a request to review links of a domain. Moreover, the method includes receiving a set of keywords to review. The method also includes accessing link information for the domain. Additionally, the method includes correlating link information for the domain to produce a representation of linkages. The method further include correlating keyword information for websites associated with links to link information in the representation of linkages. The representation of linkages includes representation of keywords on associated webpages. The method also includes presenting the representation of linkages responsive to the request.

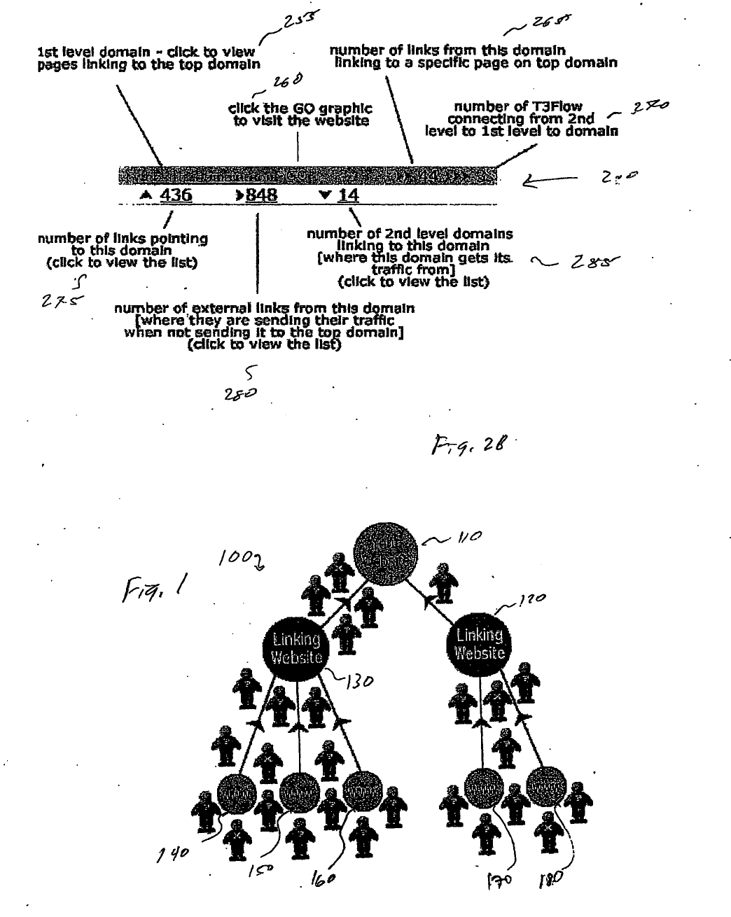

Websites and web domains come in a variety of forms, all of which are accessible through web browsers. For commercial websites, the network of linking websites can be the vital source of web traffic which allows for a successful business. FIG. 1 illustrates an embodiment of a network of websites. Network 100 is a set of websites with people illustrated to represent traffic flow to the websites. Website 110 is the website in question—the website for which traffic analysis is sought. The owner of the website may wish to see greater traffic, greater profits, or some combination of the two.

Websites 120 and 130 are websites with direct links to website 110—these may be referring websites, or websites with information which includes a link to website 110. Websites 140, 150 and 160 are websites with links to website 120. Websites 140, 150 and 160 have visitors who follow links to website 120. This is represented by icons of people moving to website 120. Similarly, websites 170 and 180 have links to website 130. Websites 140, 150 and 160 have visitors who follow links to website 130.

Both websites 120 and 130 have visitors who follow links to website 110. Thus, website 110 gets incoming traffic. This is illustrated by people moving to website 110. However, how to measure traffic from a website 140 (for example) to website 110 is not clear from this illustration. Typically, traffic statistics for a website such as website 110 only include an indication of the website supplying a link to website 110, not any further removed linkage information.

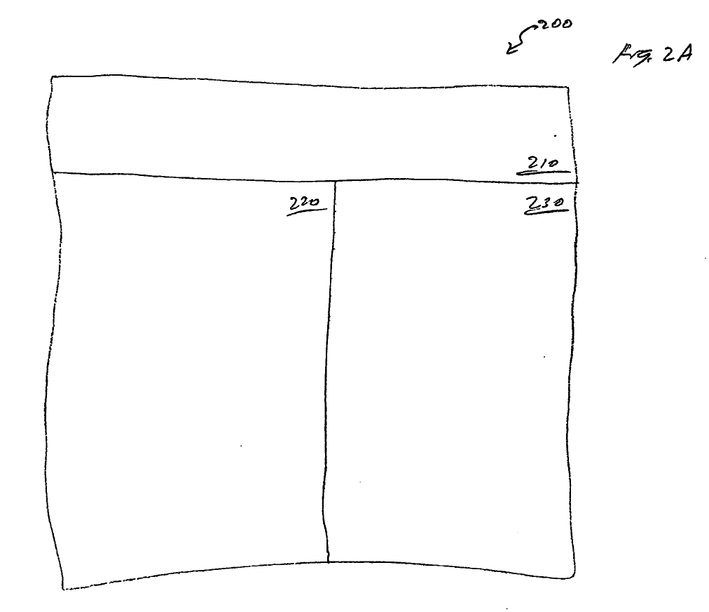

A report of where links (and thus traffic) are coming from may be provided. FIG. 2A illustrates an embodiment of a user display for reporting traffic data for a website. Interface 200 illustrates a potential format for an interactive report, which allows a user to investigate where traffic is coming from based on links. Header space 210 provides summary information, such as what website is being investigated, what links to the website are, and when information in the report was updated. Report display 220 provides information about sites (first level websites) linking to the website being investigated, and provides specific information about numbers of links to and from the first level websites, thus indicating paths to the website being investigated for each entry. Display 220 may also provide other information, such as what websites link to each entry of the report (second level websites) and which of those websites has sent a user to the website being investigated (through use of web logs, for example). Material or information displayed may be sorted by some or all of the parameters displayed, allowing for ease of use by permitting flexible display on the part of users of the reports.

Note that the discussion so far focuses on websites, but domains are just as likely to be of interest. Thus, whenever a website being investigated is mentioned, this should be understood to apply to domains as well. Similarly, linking websites may be individual webpages or domains, or some intermediate structure such as a set of webpages in some instances. Thus, webpages and domains are typically discussed interchangeably, though in some instances the distinction will be apparent.

Display 230 provides information about specific linking websites, such as when the link was found or when it was last verified, how often the link is used, and how many second-level (or higher level) websites feed into that link. Thus, display 230 may provide information for a specific website from display 220, and may be adjusted as the focus shifts from one website to another, such as through selection of various websites in display 220. Moreover, display 230 may be able to produce a variety of formats, for example.

Formats for display 220 may be varied. FIG. 2B illustrates an embodiment of an entry for a website. Report entry 250 provides a website domain, statistics on the domain, and statistics on links from the domain to the website under investigation. Field 255 provides the domain name or URL (Universal Resource Locator). Graphic 260 provides a link to the domain in question. Links field 265 provides a count of links from the domain in question to the website or domain under investigation. Traffic flow field 270 provides the number of second-level domains that have a link to a page of the domain of field 255 which specifically has a link to the website under investigation. This may be referred to as a T3flow—a potential path directly to the website or domain under investigation.

Note that in some embodiments, the first level is the website under investigation. From this, it follows that websites referring to the website under investigation (the first level) are websites on the second level. Similarly, websites referring to websites on the second level then become websites on the third level. In general, this hierarchical labeling is not used in the rest of this document—the hierarchy previously described with first level domains having links to the domain in question is used instead. However, it may be useful to bear in mind that relationships between sites and families of sites are what matter, not specific labels for the various levels of indirection which are mapped.

Other information about the domain of field 255 is also provided. Field 275 provides the number of links pointing to the domain. Field 280 provides the number of external links from the domain of field 255 (the total number of links a user may choose from at that domain or website). Field 285 provides the number of second-level domains linking to the domain in question. Thus, field 285 may illuminate the number of domains with links, whereas field 275 illuminates the number of links to the domain—further illustrating that domains may have multiple links therebetween.

Interface 200 and entry 250 may be used in a variety of embodiments. In some embodiments, link information for a domain, website or webpage may be presented in entries of a report, providing insights into relationships between websites or domains. In other embodiments, traffic or page view information is further provided, such as through use of web log information from servers, for example. Such traffic information may provide additional insights into how much links are used and thus how traffic is presently driven to a site. However, the structural relationships of the links may be reported and understood without the additional page view or traffic information. As one may expect, structural relationships of successful sites may be examined even when the owner of the site is not the person/entity ordering the report—emulation of other's success may be an option in such cases, through study of the structures surrounding a successful website. Additionally, reports may identify aggregators of users which may be useful in terms of identifying where to deploy limited marketing resources. Similarly, reports may effectively identify which sites are directly steering users to the site in question by indicating the proportion of users who visit the first level site and are then referred to the site in question.

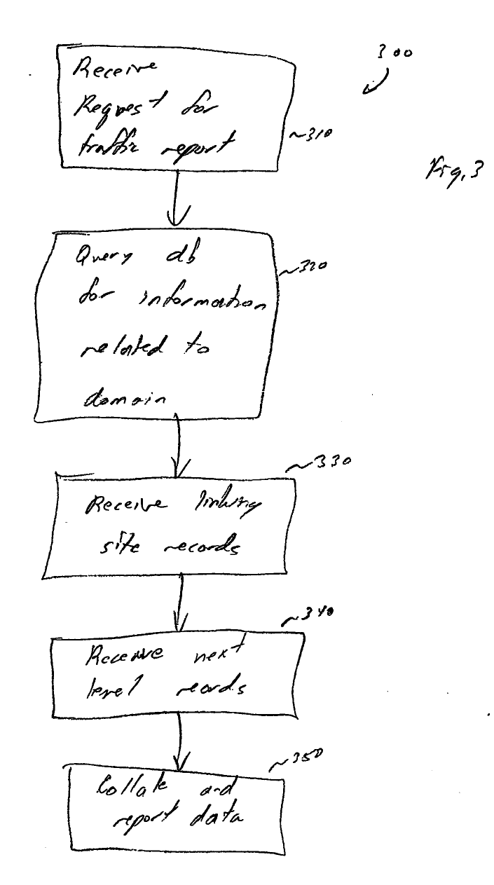

The report provided may be obtained and provided in a variety of ways. FIG. 3 illustrates an embodiment of a method of providing a report for a website. Method 300 includes receiving a request for a report, querying for information for the report, receiving records related to links and second level links, and collating and reporting the data. Method 300 and all methods of this document are composed of a set of modules which may be arranged in serial or parallel form or otherwise rearranged, for example. Moreover, such modules may be subdivided or combined in various embodiments. Additionally, such modules may be implemented as parts of a method, as software modules, or as physical modules in a system, for example.

At module 310, a request is received for a report, such as from a user who operates a website or set of websites from a domain. Module 310 may include some form of monetization, such as an up-front payment or a payment for access to enhanced features of a report. At module 320, a database of link information is queried for links to the website or domain, and for links further out in the web, such as second-level websites or domains. Such a query may involve multiple accesses of a database of link information, for example. One access may be for sites with links to the domain in question, and a second access may be for sites with links to the set of sites returned responsive to the first access or query, for example.

At module 330, records for sites with links to the domain or website are received. This may result in further queries. At module 340, records for sites with links to the sites of the records from module 330 are received, and this may result in more queries, too. The records of module 340 may be expected to be second-level sites, and may also include some sites from records from module 330, due to interdependence of websites and the non-geographical nature of linkages among websites.

At module 350, the information from the various records is collated and presented as a report. The report may take on various forms, such as a textual report with data formatted but otherwise presented in relatively raw form. The report may also take on a form of a map, showing linkages to a site or domain and linkages spreading out from there. Moreover, while a discussion of two levels of sites or domains is used for exemplary purposes, more levels may be used.

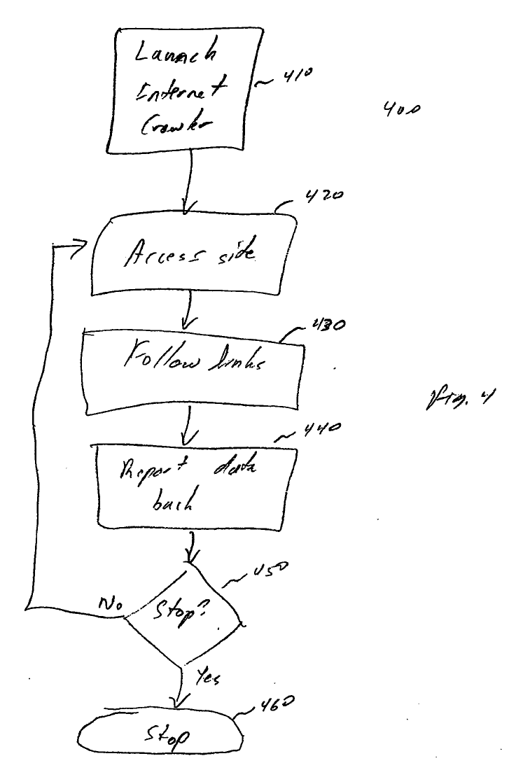

The linkage data presented in reports must come from somewhere. FIG. 4 illustrates an embodiment of a method of obtaining linkage data for websites. Method 400 includes launching an internet crawler, the crawler accessing a site, the crawler following links from the site, the crawler reporting data back, the crawler determining if it should stop, and the process ending. The crawler represents one example of a method/apparatus which may be useful for retrieving such information.

Method 400 commences at module 410, where the internet crawler is launched. At module 420, the crawler accesses a website and determines what links are present (links from that website). At module 430, the crawler begins following those links. At module 440, the crawler reports the data it has retrieved back to a designated data recipient (such as the site that launched it, for example).

At module 450, the crawler determines if it has been told to stop (such as by a signal from the site that launched it, for example). If not, the crawler accesses the next site (one of the links from the site just accessed) at module 420. If some form of stop signal has been sent, the crawler terminates at module 460. Note that the crawler has been described in terms of retrieving link information, but it may also be used to retrieve traffic information from sites if that information is available.

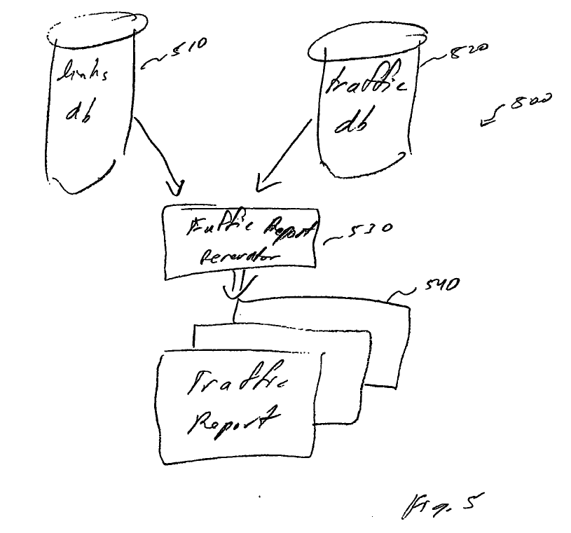

While various methods of gathering data and preparing a report may be used, those methods may be executed by a variety of systems, too. FIG. 5 illustrates an embodiment of a system for providing a report for a website. System 500 includes databases or repositories for information on links and traffic, a report generator, and resulting reports. Thus, system 500 may represent a medium embodying instructions, which, when executed, cause a processor to execute a method. Alternatively, system 500 may represent a special-purpose device, or a general purpose device configured or programmed to operate in a specific manner. Moreover, the report generated may be a physical report or an interactive electronic report, for example.

System 500, as illustrated, includes a links database 510 and a traffic database 520. These two databases contain information about links between websites and about traffic between websites, respectively. While these two databases are illustrated as separate, they need not be—they may be physically combined and logically separate, or they may be physically and logically combined for example. Importantly, the data for links and traffic may be different, but it can easily be encoded into a single record for a website, for example.

System 500 also includes a report generator 530. Generator 530 may be expected to retrieve records from databases 510 and 520, such as through queries it generates based on an initial website or domain name and on records retrieved in response to queries. Generator 530 may then be expected to collate or format the data in a manner suitable for display or printing, for example. Moreover, generator 530 may be used to retrieve traffic information (for example) from a source other than traffic database 520, such as when a user supplies traffic information from their own servers, for example.

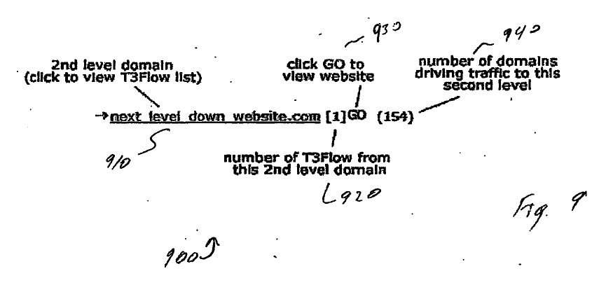

Report 540 may be expected to be a document (or documents). However, it may be formatted as a printable report (e.g. PDF) or it may be formatted as a set of HTML or similar documents for display by a web browser. It may be expected to include, in one embodiment, a set of webpages with links to the domain in question, statistics on those webpages such as information illustrated in FIG. 2B, a set of webpages with second level connections to the domain in question, statistics on webpages with second level connections such as those illustrated in FIG. 9, information about which second level webpages have been used to ultimately get to the domain in question (and how often), and other information related to internet traffic.

Note that system 500 is illustrated with a traffic database (database 520). In some embodiments, such a database may be a web log of site visits from a server, for example. In other embodiments, database 520 will be combined with database 510 into a single database. In yet other embodiments, database 520 will not be present, and the report generated will include link information but no actual traffic or page view information.

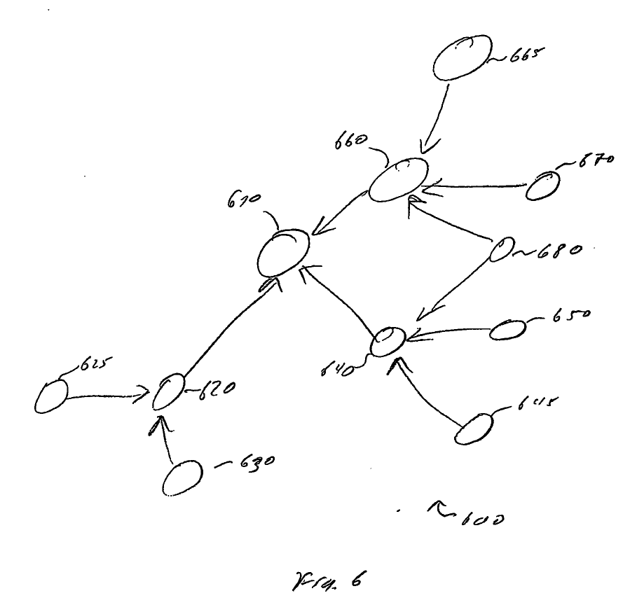

A graphic representation of a report may also be useful. FIG. 6 illustrates another embodiment of a network of websites or web domains. The illustration of FIG. 6 may be used as a report, or as an illustration of relationships between web sites. Network 600 includes a web domain or site of interest, websites with direct links, and websites linked to websites with direct links.

Site 610 is the central site under investigation. Sites 620, 640 and 660 each have a direct link to site 610, such as through a banner ad on the webpage for that site. Sites 625 and 630 have links to site 620. Sites 645 and 650 have links to site 640. Sites 665 and 670 have links to site 660. Site 680 has a link to site 640 and another link to site 660. Thus, network 600 represents a small network of websites and links therebetween. Not illustrated but potentially present are links between, for example, sites 640 and 660, or between site 665 and 670.

In some embodiments, a report is provided in a form similar to network 600—a graphical user interface is provided with sites and links represented thus. Strength of links (as measured by traffic along a link) may be represented by color or other graphical means for example. Alternatively, strength of links may be a measure of the number of links from one domain to another or to a website. Similarly, amount of traffic at various sites may be represented by color or size, for example, or number of links to a site may similarly be represented. Note that the graphical presentation in two dimensions may require that some sites be shown multiple times, such as sites that have links to many different other sites, for example. This is a natural consequence of the unlimited and unconstrained nature of links used in websites. The graphical representation may illustrate features not provided in a textual representation, however. For example, a site that provides much traffic through multiple paths may be easily observed in a graphical representation, presenting an opportunity for arrangement of a direct link between that site and the domain under investigation, for example.

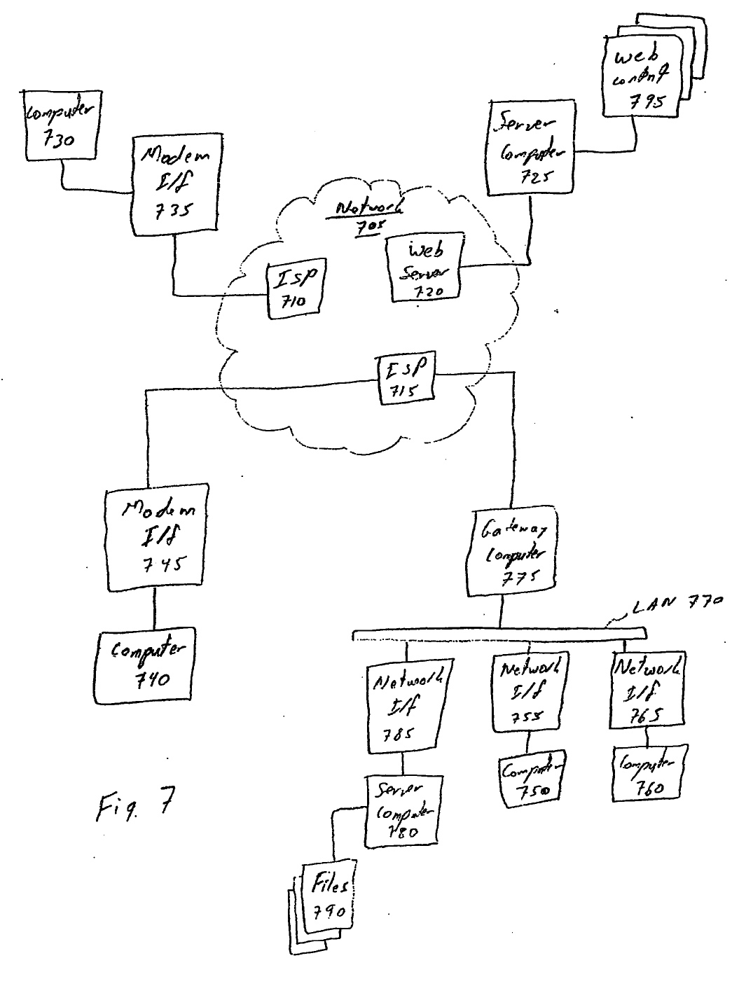

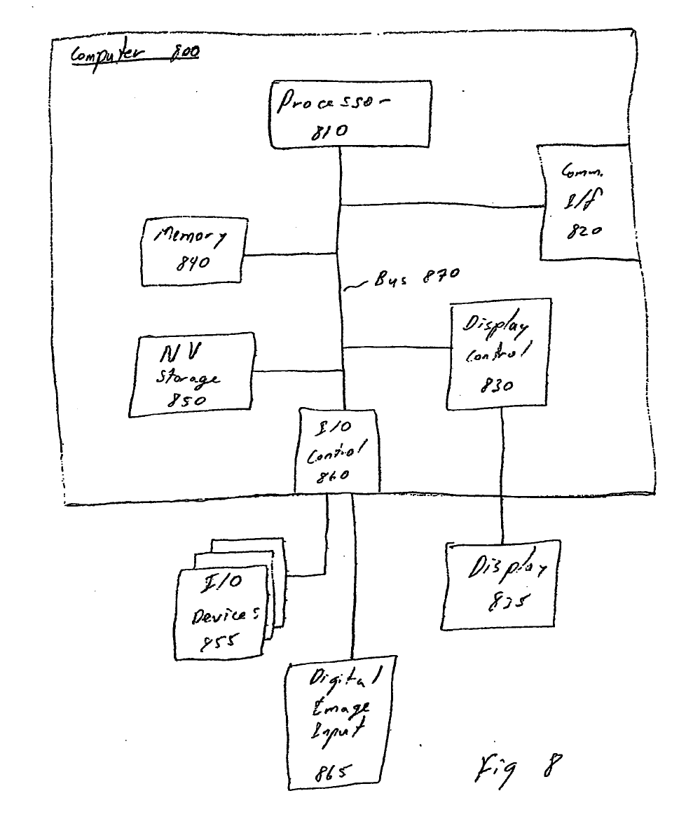

The following description of FIGS. 7-8 is intended to provide an overview of computer hardware and other operating components suitable for performing the methods of the invention described above and hereafter, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet. The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 740, 750, and 760 obtain access to the internet through the internet service providers, such as ISPs 710 and 715. Access to the internet allows users of the client computer systems to exchange information, receive and send emails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a conventional computer system that can be used as a client computer system or a server computer system or as a web server system. Such a computer system can be used to perform many of the functions of an internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

The information presented by various systems and methods may include not only information about first level sites (e.g. sites with direct links), but second level sites as well. FIG. 9 illustrates another embodiment of an entry for a website. Entry 900 may be part of a report such as report 540 of FIG. 5, or may be an entry stored for retrieval in a system such as system 800 of FIG. 8, for example.

Entry 900 includes a website address 910, a count 920 of instances of T3flow links from this website, a link 930 to the website, and a count 940 of domains sending traffic to the website at address 910. Thus, entry 900 may be a second-level website which may or may not send traffic to a website under investigation, but would be expected to have a link to a first level website, for example.

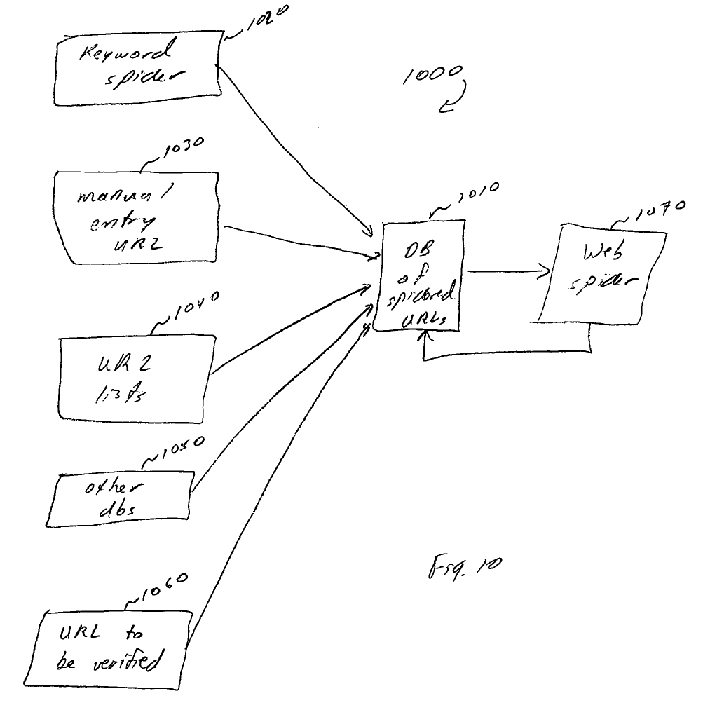

The report, in various forms, may be generated by a variety of systems. Typically, a system will accumulate links and URLs into a database and then use the database to generate the report. FIG. 10 illustrates another embodiment of a system for cataloguing links within a network. System 1000 includes a variety of sources of links, a database of links, and a web spider. Database 1010 includes URLs from various sources, along with information about what other URLs are linked to a particular URL. Thus, a select statement sent to the database 1010 as a query including a URL may be used to obtain a set of links to the URL, for example.

The various URL sources provide URLs (and potentially links) to the database 1010. Keyword spider 1020 is a spider or crawler used to find websites (and corresponding URLs) which contain particular keywords. Manual entry URL source 1030 represents manual entry of URLs which may be useful within the database 1010. URL lists 1040 represents lists of URLs which may be supplied, found or purchased for importation into database 1010. Other databases 1050 represents other databases with URL information (either dedicated URL databases or other databases) which may have records or information supplied to database 1010. URL 1060 is a URL to be verified or investigated, and would be supplied by a user or customer seeking information about the URL.

Note that one or more of these sources may be based on or part of a search engine, such as popular search engines including Google or Yahoo for example. Thus, keyword spider 1020 may include URLs found from a search engine search, URL lists 1040 may include a list of results from a search engine, or other database 1050 may include database results from such a search engine. However, because such search engines typically limit the number of URLs (or hits) returned (such as at an upper bound of 1000), relying on a search engine alone may be limiting and thus less than desirable.

Web spider 1070 is a spider or crawler which investigates URLs. As illustrated, spider 1070 uses database 1010 as a source of URLs to start from, and then may search for links from that URL to other URLs, both providing this information to database 1010 and crawling along those links to other URLs. Moreover, spider 1070 may use a list of links from a URL to verify that such links are still there, and that such links lead to retrievable URLs, thereby updating data of database 1010.

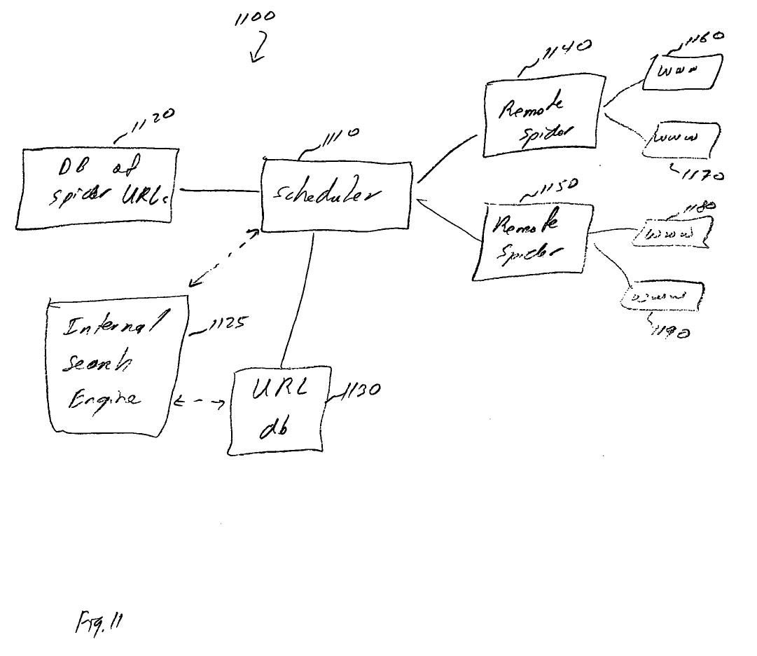

Other implementations or embodiments of systems may be used, either separately or in conjunction with system 1000, for example. FIG. 11 illustrates an alternate embodiment of a system for cataloguing links within a network. System 1100 as illustrated, includes databases of URLs, a scheduler, spiders, an internal search engine, and external websites at various URLs. Scheduler 1110 may be expected to schedule or control operations of the system, at least from the standpoint of exploring URLs. Scheduler 1110 draws URLs to be spidered or explored from database 1120 and 1130. Typically, one of 1120 and 1130 will be a database maintained by scheduler 1110 and the other will be a database with URLs which may be useful as starting points but have not otherwise been verified. As illustrated, database 1120 includes URLs which may be useful starting points that were obtained from outside sources, and database 1130 is maintained by scheduler 1110.

Remote spiders 1140 and 1150 are exemplary of spiders which may explore websites at URLs, determining what links to other URLs are present, and what keywords are present, for example. Spiders 1140 and 1150 may be part of a larger set of spiders, for example, which may be used to crawl along websites and return data to scheduler 1110. Spiders 1140 and 1150 may be remote in the sense that they operate from servers separate from scheduler 1110, and may provide periodic updates rather than a steady stream of data, for example. Exemplary of websites to explore are websites 1160, 1170, 1180 and 1190, all of which may be explored by spiders 1140 and 1150.

As scheduler 1110 receives data from spiders 1140 and 1150, database 1130 may be updated with URL information and links. Moreover, database 1130 may include keyword information for use by an internal search engine 1125. Such a search engine 1125 may be used to determine which URLs have certain keywords, and may be used to determine frequency of occurrence of keywords on associated webpages, for example. Alternatively, scheduler 1110 may provide keyword data directly to search engine 1125, allowing search engine 1125 to manage keyword data separately from database 1130, for example.

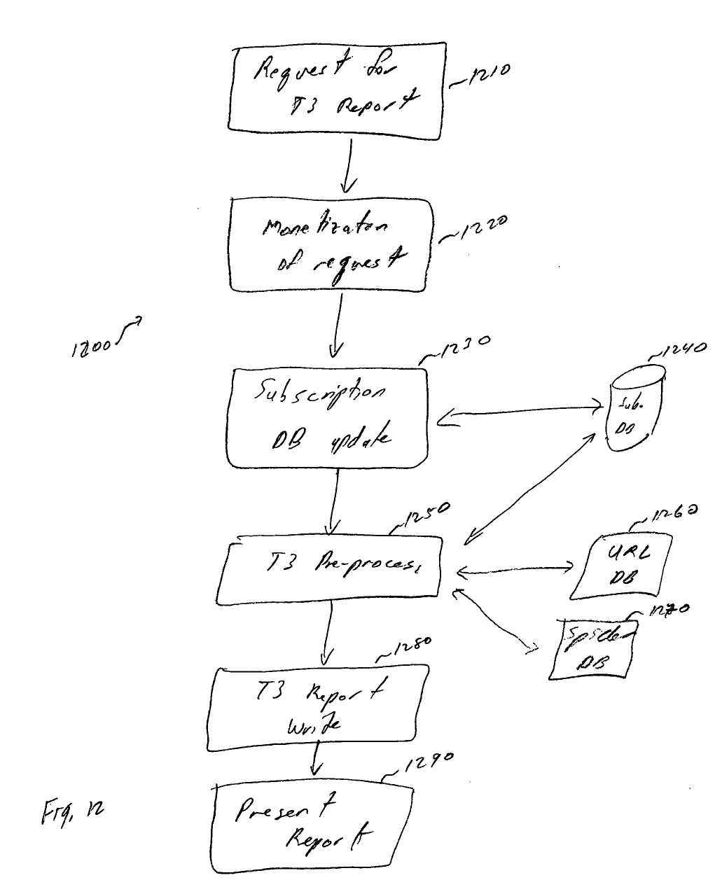

Various methods may be used for traffic or link reporting and the supporting processes related to such reporting. Moreover, embodiments may involve a consumer transaction in some instances. FIG. 12 illustrates an embodiment of a method for generating a report. Process 1200 includes a set of modules of varying types, which may be rearranged or reconfigured in some embodiments. Process 1200 inlcudes receiving a request for a report, monetization of that request, update of a subscription database, pre-processing of a report, writing of the report, and presentation of the report.

At module 1210 of process 1200, a report (T3 for example) is requested or the request is received. At module 1220, the request is monetized, such as by collecting payment from a consumer or user, or by debiting an account, or by checking payment status of a subscriber for example. At module 1230, any necessary updates to a subscriber database are performed, such as addition of a new subscriber or account information updates for example. Subscription database 1240 may be expected to include subscriber information such as identity and correspondence addresses, for example, and status information such as payment information and current status of payments for example.

At module 1250, a report is pre-processed. Pre-processing may include a variety of operations or functions. However, it may be expected to include checking a subscription database 1240 for the type of service expected to paid for, checking a URL database 1260 for which URL(s) is/are involved in the report, and checking a spider database 1270 for status of the URL(s) and for linked URLs at one or more levels. Moreover, pre-processing may include causing updates or verification of data in spider database 1270 to occur, for example. Thus, an initial report may come from the checks of databases 1260 and 1270, with a follow-up report prepared based on verified data, for example.

At module 1280, the report is actually written. By written, this may mean formatting of data retrieved from database 1270 (and 1260) for example, and may further involve editing by a user in some embodiments. For an initial report, this may be a relatively quick process which is automated. For a report with verified information, this may either be completely automated or partially automated in various embodiments. Even an initial report may have some user input in some embodiments. At module 1290, reports with link information are presented, such as for viewing on a website or by emailing to a customer, for example.

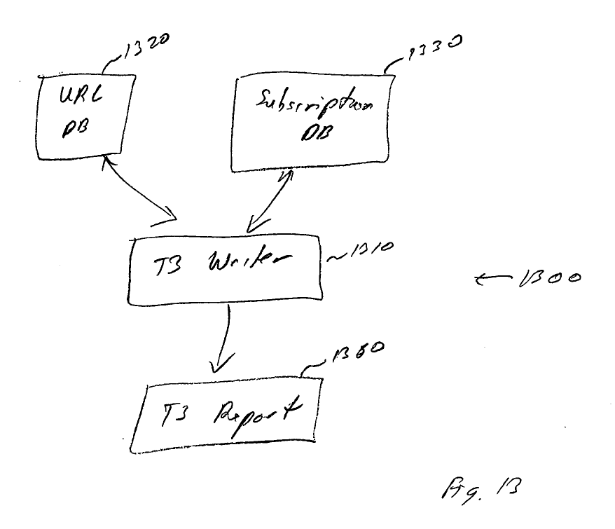

The process of FIG. 12 may be implemented by a variety of systems. FIG. 13 illustrates another embodiment of a system for generating a report. System 1300 includes a report writer, source databases, and a resulting report. Report writer 1310 may be expected to draw information for a report from a URL database 1320 and a subscription database 1330. Subscription database 1330 may include information about what services have been purchased, who purchased the report, and what formats are preferred, for example. URL database 1320 may include records of URLs and links between URLs, thus allowing for provision of records or data in response to queries about various URLs. Report writer 1310 may generate queries to each database, and then to format a report of URLs and links therebetween for a user in a format desire by the user, for example. The resulting report, report 1360, may then be presented to a user or provided to a user, for example.

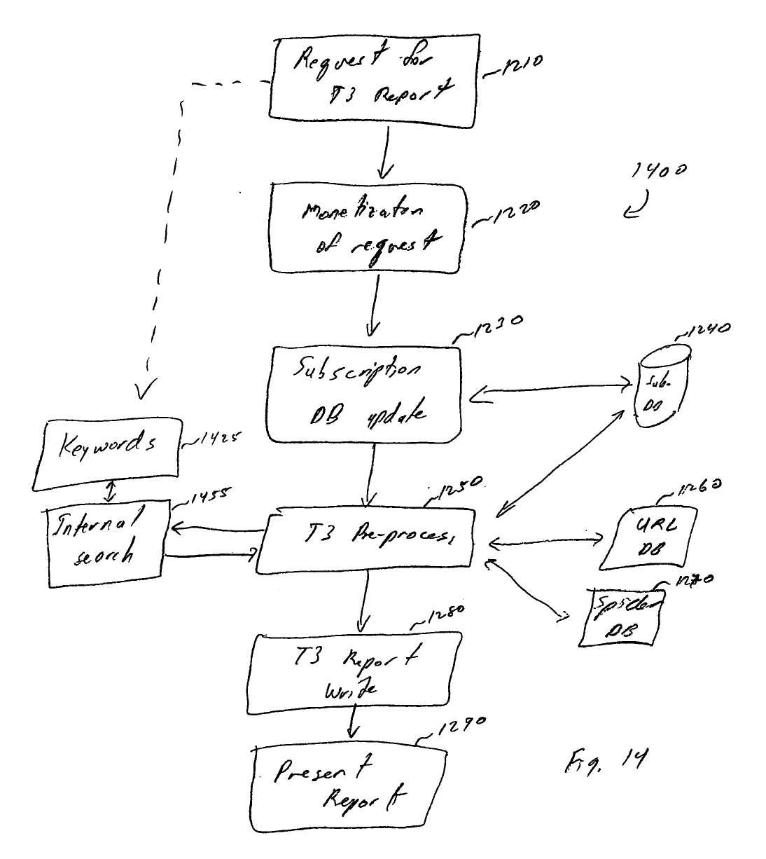

Other processes may be used to generate traffic and keyword reports, for example. FIG. 14 illustrates another embodiment of a method for generating a report including keywords. Process 1400 is similar to process 1200, with the addition of keyword information which may be used by a consumer to determine how to enhance traffic, for example. Module 1425 is a keyword module, which may involve querying for keywords from a user or receiving keywords from the user in conjunction with the request of module 1210. Moreover, keywords may be stored in subscription database 1240, with keyword module 1425 extracting or requesting those keywords, for example.

At module 1455, an internal search is performed based on keywords. The internal search may involve searching spider database 1270 with keywords from module 1425 to determine which URLs and associated websites use the keywords in question. The results may include not only which websites use keywords, but additional information such as frequency of occurrence on websites of keywords, for example. The results may then be returned to module 1250 and integrated into pre-processing of a report or writing of a report at module 1260. Moreover, the search of module 1255 may involve searching through URLs of database 1260 and may potentially involve querying external search engines in some embodiments, for example.

With keywords involved, a report may be presented which provides indications of which websites providing links use certain keywords, or how many keywords are used at various websites. If traffic is expected to be driven by keywords to some degree, this presentation may then allow for decisions about where to continue, terminate or initiate relationships such as referral relationships or other advertising relationships. Moreover, searches may involve both inclusion and exclusion of keywords, allowing for shaping of relationships (and potentially traffic) based on undesired keywords, too.

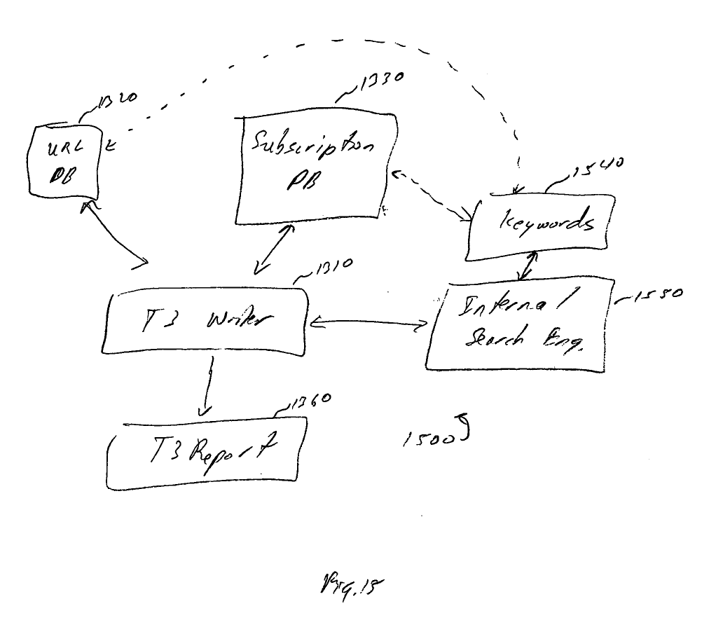

As with process 1200, various systems may be used to implement process 1400 and similar processes. FIG. 15 illustrates yet another embodiment of a system for generating a report including keywords. System 1500 illustrates how traffic or keyword searching may be integrated into system 1300, for example. In addition to the components of system 1300, system 1500 includes an internal search engine and a source of keywords. Search engine 1550 may be expected to search for keywords within a database of URLs and keywords associated with the URLs. Keyword source 1540 may represent various things in different embodiments. For example, keyword source 1540 may be an interface to a URL database 1320, allowing for keyword searching of database 1320 in a manner suited to search engine 1540, with keywords to be searched for originating with report writer 1310. Alternatively, keyword source 1540 may provide keywords to be searched for (such as from subscription database 1330 for example), with search engine 1550 then searching a database such as database 1320 or other databases for the keywords.

Results of searches from search engine 1550 may be compiled into a report 1360 by report writer 1310, providing both information on what websites and URLs link to a given URL or domain, and also what keywords are present at those websites. Report 1360 may contain an indication of whether keywords searched for are present at various websites, potentially with an indication of frequency of occurrence of those keywords, for example. Alternatively, report 1360 may contain an indication of what keywords are present at various websites without reference to a search for keywords, thus providing an indication of which keywords are presently used by such websites. All of this information may then be used by a consumer both for purposes of determining what relationships to maintain or alter, and also for purposes of altering website design.

From the foregoing, it will be appreciated that specific embodiments of the invention have been described herein for purposes of illustration, but that various modifications may be made without deviating from the spirit and scope of the invention. For example, the disclosed methods and apparatuses have been described primarily in terms of use with websites, while facilities of many different forms may be managed in the same manner. In some instances, reference has been made to characteristics likely to be present in various or some embodiments, but these characteristics are also not necessarily limiting on the spirit and scope of the invention. In the illustrations and description, structures have been provided which may be formed or assembled in other ways within the spirit and scope of the invention.

In particular, the separate modules of the various block diagrams represent functional modules of methods or apparatuses and are not necessarily indicative of physical or logical separations or of an order of operation inherent in the spirit and scope of the present invention. Similarly, methods have been illustrated and described as linear processes, but such methods may have operations reordered or implemented in parallel within the spirit and scope of the invention. Accordingly, the invention is not limited except as by the appended claims.

What is claimed is:

1. A method, comprising:
receiving a request to review links of a domain;
accessing link information for the domain;
correlating link information for the domain to produce a representation of linkages;
and
presenting the representation of linkages responsive to the request.

2. The method of claim 1, wherein:
accessing link information for the domain includes accessing information related to first-level sites having links to the domain.

3. The method of claim 2, wherein:
accessing link information for the domain includes accessing information related to second-level sites having links to the first-level sites.

4. The method of claim 1, wherein:
accessing link information for the domain includes accessing information related to first-level sites having links to the domain and second-level sites having links to the first-level sites.

5. The method of claim 1, further comprising:
launching a web crawling application;
receiving link information from the web crawling application;
and
storing the link information in a link database;
and wherein
the link information for the domain is accessed from the link database.

6. The method of claim 1, further comprising:
accessing traffic information for the domain.

7. The method of claim 1, wherein:
traffic information for the domain comes from a web log of a server of the domain.

8. The method of claim 1, wherein:
traffic information for the domain comes from a traffic database.

9. The method of claim 1, further comprising:
accessing keyword information for the domain;
and wherein
correlating link information for the domain includes correlating keyword information with link information;
and wherein
the representation of linkages includes representation of keywords on webpages.

10. The method of claim 9, further comprising:
filtering linkages in the representation of linkages based on presence of keywords at a corresponding website.

11. The method of claim 9, further comprising:
filtering linkages in the representation of linkages based on absence of keywords at a corresponding website.

12. A method, comprising:
launching a web crawling application;
receiving link information from the web crawling application;
and
storing the link information in a link database.

13. The method of claim 12, further comprising:
receiving keyword information from the web crawling application;
and
storing the keyword information in the link database.

14. The method of claim 12, further comprising:
seeding the web crawling application with links from a database of links.

15. The method of claim 12, further comprising:
seeding the web crawling application with domains from a database of links.

16. The method of claim 12, further comprising:
seeding the web crawling application with domains from a list of domains.

17. The method of claim 12, further comprising:
seeding the web crawling application with domains from a web search engine results list.

18. The method of claim 12, further comprising:
seeding the web crawling application with manually entered domains.

19. A method, comprising:
receiving a request to review traffic of a domain;
accessing traffic information for the domain;
accessing link information for the domain;
correlating link information with traffic information for the domain to produce a representation of linkages and traffic through linkages;
and
presenting the representation of linkages and traffic through linkages responsive to the request.

20. The method of claim 19, further comprising:
launching a web crawling application;
receiving link information from the web crawling application;
and
storing the link information in a link database;
and wherein
the link information for the domain is accessed from the link database.

21. The method of claim 20, further comprising:
requesting traffic information from a server;
receiving the traffic information from the server;
and
storing the traffic information in a traffic database;
and wherein
the traffic information for the domain is accessed from the traffic database.

22. The method of claim 19, wherein:
the representation of linkages includes a count of direct linkages to the domain and a count of direct linkages to sites having direct linkages to the domain.

23. The method of claim 19, wherein:
the representation of linkages includes a count of traffic along a direct link and a count of traffic along a link to a site resulting in traffic along a direct link.

24. The method of claim 22, wherein:
the representation of linkages further includes a count of secondary sites having direct linkages to sites having direct linkages to the domain where the secondary sites each have links to at least two sites having direct linkages to the domain.

25. The method of claim 19, further comprising:
monetizing presenting the representation.

26. The method of claim 19, wherein:
the method is performed by a processor executing a set of instructions, the set of instructions embodied in a machine-readable medium.

27. A method, comprising:
receiving a request to review links of a domain;
receiving a set of keywords to review;
accessing link information for the domain;
correlating link information for the domain to produce a representation of linkages;
correlating keyword information for websites associated with links to link information in the representation of linkages, the representation of linkages including representation of keywords on associated webpages;
and
presenting the representation of linkages responsive to the request.

28. The method of claim 33, further comprising:
filtering linkages in the representation of linkages based on presence of keywords at a corresponding website.

29. The method of claim 33, further comprising:
filtering linkages in the representation of linkages based on absence of keywords at a corresponding website.
